(19) United States
(12) Patent Application Publication
(10) Pub. No.: US 2008/0060012 A1
(43) Pub. Date: Mar. 6, 2008

(54) METHOD AND SYSTEM FOR DYNAMIC START CHANNEL FOR MOBILE TELEVISION

(76) Inventor: Tobias Rydenhag, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/469,570

(22) Filed: Sep. 1, 2006

(51) Int. Cl. H04N 5/445; H04N 7/10; H04N 7/025; H04N 7/16; H04H 9/00; G06F 3/00; H04H 60/33; G06F 13/00

(52) U.S. Cl. 725/46; 725/9; 725/34; 725/35

(57) ABSTRACT

A method for selecting a start-up channel upon initiation of a television application with an electronic equipment where the video data is available from a time-sliced data stream having video data corresponding to each of a plurality of channels is disclosed. The start-up channel is selected based on user preferences and/or viewing behavior of the associated user. Various techniques may be used to determine the most preferred start-up channel for a particular user. In addition, the alternative choices may also be provided to the user on the display of the electronic equipment.

### TECHNICAL FIELD OF THE INVENTION

The present invention relates generally to electronic equipment, such as electronic equipment for engaging in voice communications and/or for playing back audiovisual content to a user. More particularly, the invention relates to a method and system for selecting a start-up channel for mobile television applications based on user preferences, viewing behavior and/or a combination thereof.

### DESCRIPTION OF THE RELATED ART

Mobile and/or wireless items of electronic equipment are becoming increasingly popular. For example, mobile telephones are now in wide-spread use. In addition, the features associated with certain types of electronic equipment have become increasingly diverse. To name a few examples, many electronic equipment include cameras, text messaging capability, Internet browsing functionality, electronic mail capability, video playback capability, audio playback capability, image display capability and hands-free headset interfaces.

Some items of electronic equipment include mobile television and/or mobile radio capability. For example, mobile items of electronic equipment may be able to receive and display video content, along with outputting associated audio content. For instance, such electronic equipment may be compatible with the Digital Video Broadcasting—Handheld (DVB-H) standard for bringing broadcast services to handheld receivers. The DVB-H standard was formally adopted as ETSI standard EN 302 304 in November 2004 and is herein incorporated by reference in its entirety.

DVB-H, which falls within the set of DVB transmission standards, adapts the DVB-T system for digital terrestrial television for use with handheld, battery-powered devices. DVB-H can offer a downstream channel at high data rates for use by standalone devices or as an enhancement to mobile telecommunications networks. As will be appreciated, mobile telecommunications networks are traditionally used to provide services such as telephone communications, messaging and/or Internet access to various items of electronic equipment.

DVB-H employs time slicing technology to reduce power consumption by the receiving device. Time slicing under DVB-H involves transmitting IP datagrams as data bursts in time slots. The front end of a DVB-H compatible receiver switches on only for the time interval when the data burst of a selected service is on air. When watching television, for example, the selected service may correspond to the channel or program that the user wishes to watch. Within the short period of time corresponding to the time slots for the selected service, data is received. The data may be stored in a buffer and then passed to a decoder for generation of a video signal that may, in turn, be used to drive a display for presentation of video content to a user. There are often about ten or more bursted services in a DVB-H stream and the receiver is synchronized to receive and buffer a user selected one of the services. By ignoring the remaining services, the receiving device may save considerable battery resources. The term IP datacast is used to refer to the technical elements to create DVB-H based services and those that are used to integrate DVB-H in a hybrid network structure having both a mobile communications network such as general packet radio service (GPRS) or universal mobile telephone service (UMTS) and an additional DVB-H downstream.

DVB-H and similar downstreaming techniques, however, suffer from delays when switching from one channel to another. This delay detracts from the user experience. For many applications on mobile devices, the time it takes for an application to launch and provide usable content to the user is of importance. For example, a television application for use on a mobile telephone or a stand alone portable television device is likely used when the user is on the move. In such instances, the user desires to be entertained while having limited time available. Such situations include, for example, when the user is waiting for the train, sitting on the bus or in a taxi cab, standing in a queue, etc. Common characteristics with each of these situations is that the time to be spent utilizing the television application is limited. If the user determines that the process of picking up the mobile telephone, starting the television application and finding something interesting to watch takes too much time, the user may decide that it is not worth the effort to start the application. In such cases, the user will likely use the television application less frequently, for example, when the user has more spare time.

Manufactures and developers of portable devices, including mobile telephones that utilize television applications have addressed television application start-up time by shortening start-up time and buffering times. In addition, they may also include a hot key on the portable device, which starts the application when depressed or otherwise activated. However, none of these improvements solve the problem of quickly finding a start-up channel that the user will likely find content interesting to watch based on the user's preferences and/or viewing behavior.

### SUMMARY

In view of the aforementioned shortcomings associated with conventional television applications resident on portable communication devices, there is a strong need in the art for a method and apparatus for selecting a start-up channel based on user preferences and/or viewing behavior.

Aspects of the present invention are directed to reducing the amount of time that the user may have to wait before being able to view a video presentation when the use initiates a television application in an electronic equipment.

According to one aspect of the invention, a method of selecting a start-up channel with an electronic equipment that receives video data from a time-sliced data stream having video data corresponding to each of a plurality of channels, comprising: collecting information about an associated user's video viewing preferences; processing the information; and determining a start-up channel based upon the collected information.

Another aspect of the invention relates to collecting user channel selection behavior for patterns in channel selection.

Another aspect of the invention relates to collecting accumulated view time of each channel.

Another aspect of the invention relates to collecting a frequency with which the user selects each channel.

Another aspect of the invention relates to collecting information on programs viewed by the associated user.

Another aspect of the invention relates to collecting information on a type of show the associated user views.

Another aspect of the invention relates to collecting information on programs viewed by the associated user on a particular date.

Another aspect of the invention relates to collecting information on programs viewed by the associated user at a particular time.

Another aspect of the invention relates to collecting information on programs viewed by the associated user on a weekend and on a weekday.

Another aspect of the invention relates to processing the collected information using an algorithm to determine the start-up channel.

Another aspect of the invention relates to processing at least one parameter from the collected information.

Another aspect of the invention relates to processing the collected information using a weighted average of a plurality of the collected information.

Another aspect of the invention relates to receiving video data corresponding to the start-up channel and driving a display in accordance with the video data corresponding to the start-up channel.

Another aspect of the invention relates to displaying one or more alternative channels on the display.

Another aspect of the invention relates to the electronic equipment being a mobile telephone.

According to one aspect of the invention, an electronic equipment, comprising: a memory for collecting information about an associated user's video viewing preferences; a controller coupled to the memory, wherein the controller processes the information in a predetermined manner to select a start-up channel; and a display coupled to the processor for displaying video content corresponding to the selected start-up channel.

Another aspect of the invention relates to the electronic equipment being a mobile telephone.

Another aspect of the invention relates to the display including a one or more alternative channels in a text format.

According to one aspect of the invention, a program stored on a machine usable medium selecting a start-up channel with an electronic equipment that receives video data from a time-sliced data stream having video data corresponding to each of a plurality of channels, the program comprising executable logic to: collect information about an associated user's video viewing preferences; process the information in a predetermined manner; determine a start-up channel based upon the collected information; receive video data corresponding to the start-up channel; and drive a display in accordance with the video data corresponding to the start-up channel

Another aspect of the invention relates to the program including logic to drive a display to display one or more alternative channels on the display.

Another aspect of the invention relates to the program including logic to collect information monitors user behavior and/or viewing preferences to determine the start-up channel.

Another aspect of the invention relates to the program, wherein the logic to determine the start-up channel utilizes more than one of the associated user's video viewing preferences.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic view of a mobile telephone as an exemplary electronic equipment in accordance with an embodiment of the present invention;

FIG. 2 is a time line showing data bursts delivered in time sliced arrangement;

FIG. 3 is a schematic block diagram of the relevant portions of the mobile telephone of FIG. 1 in accordance with an embodiment of the present invention; and

FIG. 4 is a flow chart of an exemplary channel prediction function carried out by the mobile telephone of FIG. 1 in accordance with an embodiment of the present invention.

FIG. 5 is an exemplary display in accordance with aspects of the present invention.

### DETAILED DESCRIPTION OF EMBODIMENTS

The present invention will now be described with reference to the drawings, wherein like reference numerals are used to refer to like elements throughout.

The term “electronic equipment” includes portable radio communication equipment. The term “portable radio communication equipment,” which herein after is referred to as a “mobile radio terminal,” includes all equipment such as mobile telephones, pagers, communicators, i.e., electronic organizers, personal digital assistants (PDAs), smartphones, portable communication apparatus or the like.

In the present application, the invention is described primarily in the context of a mobile telephone. However, it will be appreciated that the invention is not intended to be limited to a mobile telephone and can be any type of appropriate electronic equipment. Other exemplary types of electronic equipment that may benefit from aspects of the present invention include audio and/or video playback devices (e.g., MP3 players, DVD players, etc.) having mobile television and/or radio receiving capability.

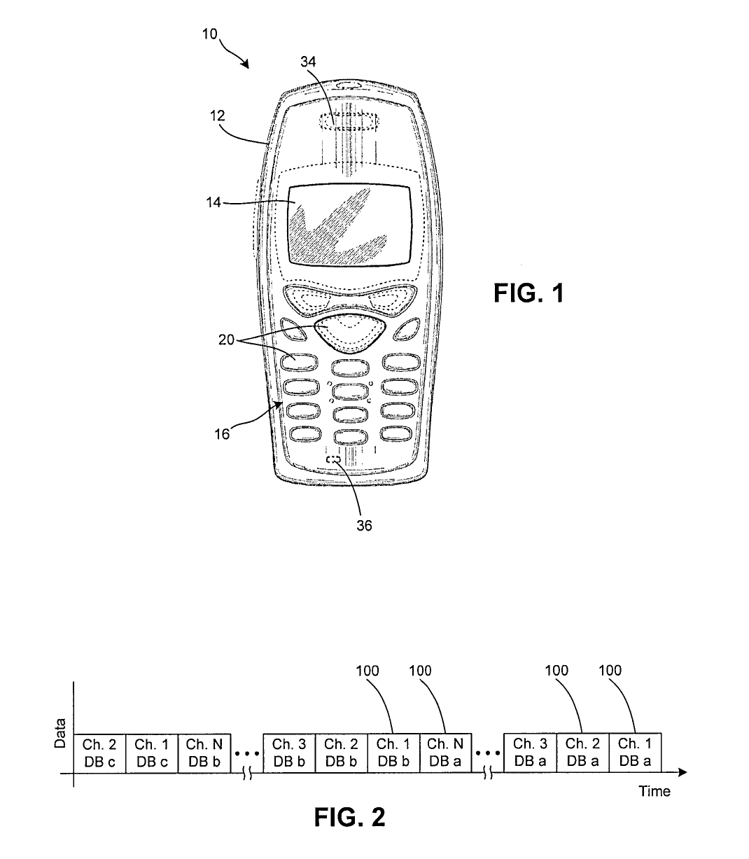

Referring initially to FIG. 1, an electronic equipment 10 is shown in accordance with the present invention. The electronic equipment includes a start-up channel selection function that is configured to select a start-up channel based on the user's preferences and/or viewing behavior when the mobile television application is initiated. It will be appreciated that the start-up channel selection function may be embodied as executable code that may be resident in the electronic equipment 10.

The term “channel” will be used to broadly mean any one of multiple broadcast services that may be received by the electronic equipment. Accordingly, each channel may correspond to a television station or a radio station. Channels may also correspond to a set of programs offered by a television, video, radio, music and/or other content service (e.g., there may be one service provider that offers a number of programs, such as in the form of a play list).

In one embodiment, plural channels are broadcast to the electronic equipment 10 using a time slice protocol, such as DVB-H. Under the DVB-H standard, each channel may be referred to as a service. The time slice protocol may involve transmitting IP datagrams for each channel as data bursts in corresponding time slots.

With additional reference to FIG. 2, a series of time sliced data bursts 100 for plural channels is illustrated. In the data transmission sequence, a first data burst (DB a) for a first channel (Ch. 1) is followed by a first data burst (DB a) for a second channel (Ch. 2), which is followed by a first data burst (DB a) for a third channel (Ch. 3). The string of first data bursts (DB a) continues until the last channel (Ch. N) is reached, after which a second data burst (DB b) for each channel is sequentially transmitted and then a third data burst (DB c) for each channel is sequentially transmitted, and so on.

Upon initiation of the mobile television application, a start-up channel is selected by the start-up selection function. The mobile television application may be initiated by any mechanism. For example, the mobile television application may be initiated by the user depressing a function key, a specially designated key, a series of keys, by the user selecting the application using a drop down menu, etc.

A receiver of the electronic equipment 10 is tuned to the start-up channel by tuning the receiver to the selected channel. As discussed below, the channel to which the receiver is tuned is typically selected by the user's preferences, viewing behavior and/or a combination of the user's preferences and viewing behavior. The receiver is configured to be synchronized to the data bursts of the selected channel. The data bursts for the selected channel are received by the receiver and decoded so that a displayable video signal and associated audio signal are generated, but the remaining data bursts are ignored. To generate the video and audio signals, the data bursts for the selected channel are assembled to effectively bridge the time elapsing between data bursts for the selected channel and during which data bursts for other channels are transmitted.

In the description herein, the transmitted and processed data is audiovisual data. It will be understood that other data formats may be transmitted in time sliced manner, such as audio data, image data, files, software programs, etc., and aspects of the present invention may be applied to the processing of data formats other than audiovisual data.

With continued reference to FIG. 1, the illustrated electronic equipment 10 is a portable, battery powered device. The electronic equipment in the exemplary embodiment is a mobile telephone and will be referred to as the mobile telephone 10. The mobile telephone 10 is shown as having a “brick” or “block” design type housing 12, but it will be appreciated that other type housings, such as a clamshell housing or a slide-type housing, may be utilized without departing from the scope of the invention.

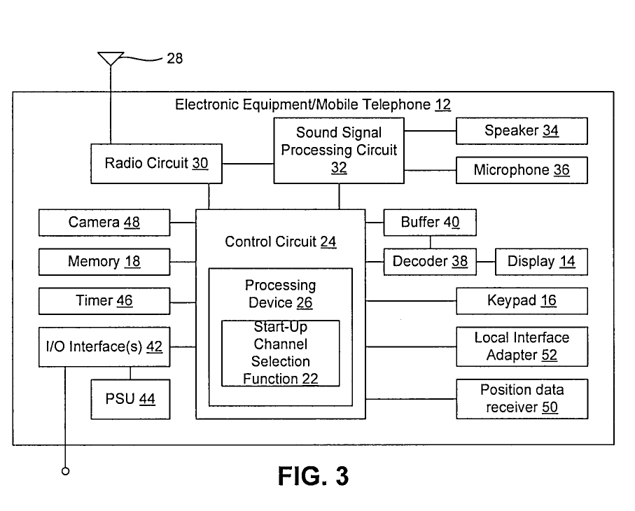

The mobile telephone 10 includes a display 14 and keypad 16. As is conventional, the display 14 displays information to a user such as operating state, time, telephone numbers, contact information, various navigational menus, etc., which enable the user to utilize the various feature of the mobile telephone 10. The display 14 may also be used to visually display content received by the mobile telephone 10 and/or retrieved from a memory 18 (FIG. 3) of the mobile telephone 10.

Similarly, the keypad 16 may be conventional in that it provides for a variety of user input operations. For example, the keypad 16 typically includes alphanumeric keys 20 for allowing entry of alphanumeric information such as telephone numbers, phone lists, contact information, notes, etc. In addition, the keypad 16 typically includes special function keys such as a “call send” key for initiating or answering a call, and a “call end” key for ending, or “hanging up” a call. Special function keys may also include menu navigation keys, for example, for navigating through a menu displayed on the display 14 to select different telephone functions, profiles, settings, etc., as is conventional. Other keys associated with the mobile telephone may include a volume key, audio mute key, an on/off power key, a web browser launch key, a camera key, etc. Keys or key-like functionality may also be embodied as a touch screen associated with the display 14.

The mobile telephone 10 includes conventional call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc.

FIG. 3 represents a functional block diagram of the mobile telephone 10. With the exception of a start-up channel selection function 22 according to the present invention, which is preferably implemented as executable logic in the form of application software or code within the mobile telephone 10, the construction of the mobile telephone 10 is otherwise generally conventional. The mobile telephone 10 includes a primary control circuit 24 that is configured to carry out overall control of the functions and operations of the mobile telephone 10. The control circuit 24 may include a processing device 26, such as a CPU, microcontroller or microprocessor. The processing device 26 executes code stored in a memory (not shown) within the control circuit 24 and/or in a separate memory, such as memory 18, in order to carry out conventional operation of the mobile telephone 10. The memory 18 may be, for example, one or more of a buffer, a flash memory, a hard drive, a removable media, a volatile memory, a non-volatile memory or other suitable device. In addition, the processing device 26 executes code in accordance with the present invention in order to perform the start-up channel selection function 22.

It will be apparent to a person having ordinary skill in the art of computer programming, and specifically in applications programming for mobile telephones or other items of electronic equipment, how to program a mobile telephone 10 to operate and carry out the functions described herein. Accordingly, details as to the specific programming code have been left out for sake of brevity. Also, while the start-up channel selection function 22 is executed by the processing device 26 in accordance with the preferred embodiment of the invention, such functionality could also be carried out via dedicated hardware, firmware, software, or combinations thereof, without departing from the scope of the invention.

Continuing to refer to FIGS. 1 through 3, the mobile telephone 10 includes an antenna 28 coupled to a radio circuit 30. The radio circuit 30 includes a radio frequency transmitter and receiver for transmitting and receiving signals via the antenna 28 as is conventional. The radio circuit 30 may be configured to operate in a mobile communications network, as well as to receive time sliced datagrams or other data transmissions. For example, the receiver may be an IP datacast compatible receiver compatible with a hybrid network structure providing mobile communications and DVB-H based or similar services.

The mobile telephone 10 further includes a sound signal processing circuit 32 for processing the audio signal transmitted by/received from the radio circuit 30. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 24 so as to carry out overall operation.

The mobile telephone 10 also includes the aforementioned display 14 and keypad 16 coupled to the control circuit 24. The display 14 may be coupled to the control circuit 24 by a video decoder 38 that converts video data to a video signal used to drive the display 14. The video data may be retrieved from a video file that is stored in the memory 18 or from received video data. Prior to being feed to the decoder 38, the video data may be buffered in a buffer 40.

The mobile telephone 10 further includes one or more I/O interface(s) 42. The I/O interface(s) 42 may be in the form of typical mobile telephone I/O interfaces and may include one or more electrical connectors. As is typical, the I/O interface(s) 42 may be used to couple the mobile telephone 10 to a battery charger to charge a battery of a power supply unit (PSU) 44 within the mobile telephone 10. In addition, or in the alternative, the I/O interface(s) 42 may serve to connect the mobile telephone 10 to a wired personal hands-free adaptor (not shown). Further, the I/O interface(s) 42 may serve to connect the mobile telephone 10 to a personal computer or other device via a data cable or wireless link, etc. The mobile telephone 10 may receive operating power via the I/O interface(s) 42 when connected to a vehicle power adapter or an electricity outlet power adapter.

The mobile telephone 10 may also include a timer 46 for carrying out timing functions. Such functions may include, for example, timing the durations of calls, generating the content of time and date stamps, timing the duration a television channel is viewed, etc.

As indicated, the mobile telephone 10 may be configured to operate in a communications system (not illustrated). The system can include a server or servers for managing calls placed by and destined to the mobile telephone 10, transmitting data to the mobile telephone 10 and carrying out any other support functions. The server communicates with the mobile telephone 10 via a network and a transmission medium. The transmission medium may be any appropriate device or assembly, including, for example, a communications tower, another mobile telephone, a wireless access point, a satellite, etc. Portions of the network may include wireless transmission pathways.

The mobile telephone 10 may include a camera 48 for taking digital pictures and/or movies. Image and/or video files corresponding to the pictures and/or movies may be stored in the memory 18.

The mobile telephone 10 also may include a position data receiver 50, such as a global positioning satellite (GPS) receiver, Galileo satellite system receiver or the like.

The mobile telephone 10 also may include a local wireless interface 52, such as a Bluetooth adaptor, for establishing communication with an accessory, hands-free adaptor, computer or other device.

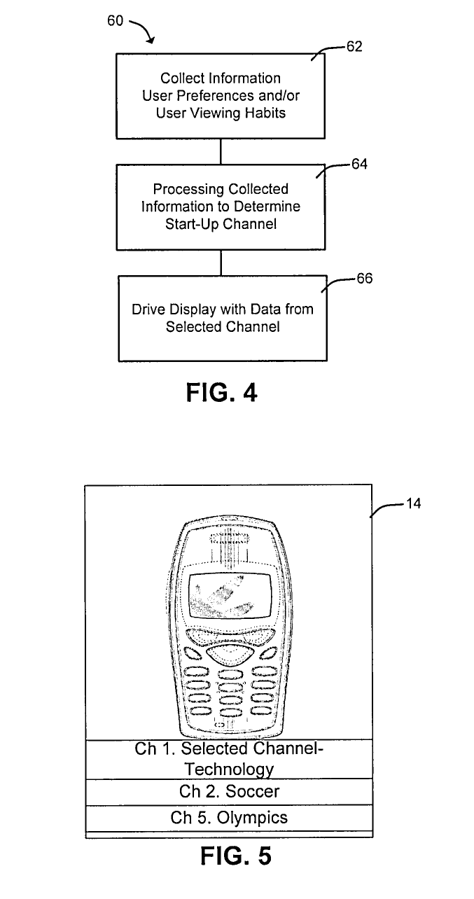

Referring to FIG. 4 a method of selecting a start-up channel with an electronic equipment that receives video data from a time-sliced data stream having video data corresponding to each of a plurality of channels is depicted. The functionality of the method may be carried out by the mobile telephone 10. For example, the functionality of the method may be embodied as executable code and/or executable logic, such as in the form of the start-up channel selection function 22, or any other suitable form, including software, firmware, dedicated circuit components, computer readable media, machine usable medium and so forth.

Although the illustrated method shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores, or messages may be added to the logical flow for purposes of enhanced utility, accounting, performance, measurement, troubleshooting, and the like. It is understood that all such variations are within the scope of the present invention.

The exemplary method 60 includes at block 62 collecting information about an associated user's video viewing preferences and/or user preferences. The collected information is processed at block 64 to determine a start-up channel based upon the collected information. At block 66, the data associated with the selected channel is fed to the decoder 38 for generation of the video signal used to drive the display 14 for viewing by the user.

Any desirable information associated with the user's video preferences may be collected by any manner (e.g., manually filling in a checklist, automatically monitoring user activity, etc.). Exemplary information may include, for example, a listing of favorite programs, information related to the user's actual viewing of video presentations, the channel selected by the user, the amount of time the user views a particular video presentation and/or channel, the date and/or time a video presentation is watched by the user, accumulated view time for each channel, frequency with which the user selects each channel, etc. One of ordinary skill in the art will readily appreciate that any number and/or variety of parameters may be collected in accordance with the present invention.

The collected information may be stored in memory 18 associated with the electronic equipment 12. Alternatively the collected information may be stored on disk drive (not shown) or other storage medium associated with the electronic equipment 12.

As indicated above, there can be an appreciable delay (e.g., often on the order of about three to six seconds) from the time the user initiates the television application to when the video presentation corresponding to the selected channel is displayed on the display 14. In systems using DVB-H or other time slicing protocol, there is a great emphasis on using the receiver (e.g., radio circuit 30) to receive data corresponding to the selected channel and ignore other channels to conserve battery life. Since services are broadcast in time slot arrangement, however, switching from one channel to another channel may be time consuming. In particular, time elapses by waiting for the time slot of the newly selected channel to arrive and waiting for an acceptable amount of data to be buffered before decoding starts.

To reduce the start-up delay and/or time to find a program of that interests the user, the method 60 proceeds to blocks 64 and 66 where a predicted start-up channel is processed and determined. Predicting the start-up channel that the user may select to view may be carried in a number of different ways. Exemplary techniques for carrying out the start-up channel selection are described herein, but other techniques and/or modifications to the described techniques are possible and are considered to fall within the scope of the claims appended hereto.

In one embodiment, the mobile telephone 10 relies on only one technique to select the start-up channel. In other embodiments, the mobile telephone uses plural techniques to select the start-up channel. For instance, user behavior may be monitored and one technique from multiple possible techniques is employed based on the monitored behavior (e.g., the techniques are placed in a hierarchy and based on current user behavior and/or current time and date, one technique may be used over another technique). In another embodiment, multiple techniques may be combined by merging the processes, user behavior monitoring and/or decision making algorithm of the techniques. In other embodiment, multiple techniques may be separately used to predict the start-up channel under each technique and the results of each technique may be combined using a weighting scheme to generate the start-up channel.

One example technique for selecting the start-up channel is to base the start-up channel selection on previous choices that the user has exhibited a propensity to make. For example, monitoring of user behavior may reveal that the user has a pattern (e.g., “modus operandi”) when making channel selection, such as selecting from only a few channels from a larger number of available channels when attempting to find content of interest. If monitoring reveals that the channels tend to be selected in a particular order and/or with a particular frequency, the accuracy of this technique may be improved. Other associated behavior may be used under this technique, such as observing that once a user has briefly viewed a channel but then selects another channel, the briefly viewed channel is not typically selected again for a certain amount of time. Other observable behavior may include observing the types of channel selections that the user makes based on the time of day and/or day of the week. As will be appreciated, various additional and/or alternative statistical analysis techniques may be used to assess the user's behavior and make a start-up channel selection that maximizes the viewer's experience.

In one embodiment, the particular channels of most interest to the user and/or the order of selection may result in the generation of a “favorites” style channel selection list by the mobile telephone 10. In a variation of the foregoing technique, the user may construct a list of favorite channels to view with an associated order. Different lists may be generated for different times of day and/or different days of the week. No matter how the list is generated, the start-up channel selection may be made based on the selection list.

Another example technique involves monitoring the accumulated view time of each available channel. Monitoring accumulated view time may reveal that the user tends to watch certain channels over other channels. For instance, a score or percentage value may be associated with each channel. The channel with the highest score or percentage value may be selected as the start-up channel. Accumulated view time may be measured by monitoring the length of time that the user has historically viewed each channel and/or cover a predetermined period of time (e.g., a day, a week, two weeks, a month, three months, etc.)

Another example technique involves monitoring the accumulated frequency with which the user has historically selected each available channel for viewing (e.g., the number of times each channel is selected independent of length of time watched). Monitoring accumulated selection frequency may reveal that the user tends to watch certain channels over other channels. For instance, a score or percentage value may be associated with each channel. The channel with the highest score or percentage value may be selected as the start-up channel.

In another embodiment, the accumulated view time and the accumulated selection frequency from the preceding two example techniques may be combined to derive a score for each channel. Such a score may be used for selection of the start-up channel by indicating the most frequently watched channels and the duration with which those channels are watched.

Another example technique includes using a content based metric. This technique is based on the assumption that a user is likely to return to particular programming that he or she views often or with regularity. For example, it is possible to monitor for user selection of recurring shows or program series. If a regularly watched show airs at a particular time on a daily or weekly basis and, when that time arrives, upon initiation of the television application, the selected start-up channel may be the channel on which the show airs.

Another form of using a content based metric may be based on type of content and monitored behavior. For example, content and/or the type of content aired by each channel may be ranked against regularly watched types of programs, artists and/or actors to select the start-up channel. Categories of regularly watched content and how often or frequently each are watched may be developed. An example set of categories could include sporting events in general, particular types of sports (e.g., football/soccer, American football, basketball, etc.), particular sporting teams, news programs in general, particular types of news programs (e.g., national news, local news, business and financial news, etc.), cooking shows, music videos, and so forth.

Another example technique may include using channel popularity ratings. This technique is based on the assumption that the more popular a channel is, the more likely the user is to select the channel. The channels may be ranked by popularity and the most popular channel may be used as the predicted start-up channel selection. This technique may use static or dynamic ratings. Static rating may be used to rank each channel according to overall viewership across all time slots. Dynamic ratings may be used to rank each channel according to viewership at the particular time to take into consideration the popularity of the currently aired content. Therefore, dynamic ratings would place the most popular channel for the particular time ahead of other channels, even if that channel is not as popular at other times.

Demographic information may also be used in ranking the channels by popularity and/or some other metric. For example, if the user is male and between the ages of 16 and 24, the most popular channels for such an individual may differ from the most popular channels for a female between the ages of 45 and 60.

Another technique for selecting the start-up channel is to use the channel selected immediately before the last channel selected (e.g., when the television application was turned off). This technique is based on an assumption that the user will return to the previously selected channel from the last channel selected. This technique may work particularly well when monitoring of user behavior indicates that the user frequently switches back and forth between two channels. For instance, a user may be interested in the content currently being aired by two channels and will switch at opportune times from one channel to the other and back to the first channel. If the user is switching between two channels, it is likely that the next time the user selects a different channel from the last channel selected, the other of the two will be selected. This technique may be implemented by tracking user behavior and recognizing a pattern of switching back and forth between two channels.

As indicated, the start-up channel selection technique used at any particular time may be selected based on user preferences, monitored user behavior, time of day and/or day of the week, etc. Aspects from one or more techniques may be merged with or integrated with another technique. Accordingly, each technique should be considered combinable with every other technique. Aspects of each technique may be modified over time to improve the accuracy of the viewing behavior of the user with respect to the selected start-up channel. In one embodiment, multiple techniques may be separately used to select the start-up channel under each technique and the results of each technique may be combined using a weighting algorithm to generate a start-up channel. For instance, the result of each technique may be given a weighted score. The score for each predicted start-up channel may be summed and the highest summed score may be used as the selected start-up channel. The following table serves as example of a weighting technique to combine the results separately derived by plural techniques to select the start-up channel.

TABLE 1

| Technique | | Predicted | Weight by predicted channel | | | | |
|---|---|---|---|---|---|---|---|
| No. | Weight | channel | Ch. 1 | Ch. 2 | Ch. 3 | Ch. 4 | Ch. 5 |
| 1 | 0.10 | 2 | — | 0.10 | — | — | — |
| 2 | 0.15 | 2 | — | 0.15 | — | — | — |
| 3 | 0.30 | 4 | — | — | — | 0.30 | — |
| 4 | 0.10 | 5 | — | — | — | — | 0.10 |
| 5 | 0.15 | 5 | — | — | — | — | 0.15 |
| 6 | 0.10 | 4 | — | — | — | 0.10 | — |
| 7 | 0.10 | 2 | — | 0.10 | — | — | — |

| | | | | | |
|---|---|---|---|---|---|
| Total: | 0.00 | 0.35 | 0.00 | 0.40 | 0.25 |

In the example of Table 1, seven techniques are used to make start-up channel predictions from five possible channels (e.g., channels 1-5). A weight is assigned to each technique. None of the techniques predicted channel 1 or channel 3 would be the preferred selected start-up channel and those channels' overall score is zero. However, three techniques predicted channel 2 would be a preferred start-up channel. The three techniques gave channel 2 respective weighting scores of 0.10, 0.15 and 0.10 for a total channel 2 score of 0.35. Two techniques predicted channel 4 would be the preferred start-up channel for a total channel 4 score of 0.40. Two techniques predicted channel 5 would be the preferred start-up channel for a total channel 5 score of 0.25. In the example, channel 4's score is higher than the total score of all other channels and may be selected as the start-up channel.

The weighting values may be static or dynamic. Dynamic weighting values may be used to adjust for factors such as of day and/or day of the week, and/or to improve the accuracy of the prediction over time by tracking preferred start-up channel selection versus actual viewer viewing habits. For example, if one of the techniques is more accurate than the others, the weight for that technique may be increased.

In another embodiment, the channel having the most number of techniques predicting the channel may be used as the predicted channel. Using the example from Table 1, channel 2 has the highest number of predicting techniques. Therefore, channel 2 may be selected as the start-up channel.

When weight score is used to predict the channel, a tie between two or more channels having the same score may be broken by using a secondary metric, such as the channel from the tied channels with a higher number of techniques predicting the channel. Similarly, when higher number of techniques is used to predict the channel, a tie between two or more channels having the same number of predicting techniques may be broken by using higher weighted score. As will be appreciated, other tie breaking or hierarchical schemes may be used as part of the prediction process.

With continued reference to FIG. 4, after selecting the start-up channel, the method may proceed to block 66. In block 66, the data associated with the selected channel is fed to the decoder 38 for generation of the video signal used to drive the display. Similarly, any audio data associated with the video data may be decoded for broadcasting as sounds or transmission to an accessory for broadcasting as sounds.

While start-up channel selection method consumes computing resources, the user's experience may be enhanced by reducing the time from initiating the television application and viewing video information of interest to the user. As will be appreciated, the method may be extended to predict more than one possible start-up channel that the user may also select. For example, in addition to displaying data associated with the selected start-up channel, it may be beneficial to identify alternative channels that may be of interest to the viewer. This information could be presented in text or graphic format in a portion of the display, as shown in FIG. 5. As illustrated in FIG. 5, the selected channel is a technology channel that is showing an exemplary mobile telephone. Below the picture of the mobile telephone, there is information related to the next two most probable choices that may interest the viewer, namely, soccer on channel 2 and the Olympics on channel 5. While shown below the displayed data of the selected channel, the information may also be presented in an overlay over the video presentation of the selected start-up channel.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

What is claimed is:

1. A method of selecting a start-up channel with an electronic equipment that receives video data from a time-sliced data stream having video data corresponding to each of a plurality of channels, comprising:
a) collecting information about an associated user's video viewing preferences;
b) processing the information; and
c) determining a start-up channel based upon the collected information.

2. The method of claim 1, wherein the step of collecting information includes monitoring user channel selection behavior for patterns in channel selection.

3. The method of claim 1, wherein the step of collecting information includes monitoring accumulated view time of each channel.

4. The method of claim 1, wherein the step of collecting information includes monitoring a frequency with which the user selects each channel.

5. The method of claim 1, wherein the step of collecting information includes monitoring programs viewed by the associated user.

6. The method of claim 1, wherein the step of collecting information includes monitoring a type of show the associated user views.

7. The method of claim 1, wherein the step of collecting information includes monitoring programs viewed by the associated user on a particular date.

8. The method of claim 7, wherein the step of collecting information includes monitoring programs viewed by the associated user at a particular time.

9. The method of claim 1, wherein the step of collecting information includes monitoring programs viewed by the associated user on a weekend and on a weekday.

10. The method of claim 1, wherein the collected information is processed using an algorithm to determine the start-up channel.

11. The method of claim 10, wherein the information is processed using at least one parameter of the collected information.

12. The method of claim 10, wherein the information is processed using a weighted average of a plurality of the collected information.

13. The method of claim 1 further including receiving video data corresponding to the start-up channel and driving a display in accordance with the video data corresponding to the start-up channel.

14. The method of claim 13, further including displaying one or more alternative channels on the display.

15. The method of claim 1, wherein the electronic equipment is a mobile telephone.

16. An electronic equipment, comprising:
a memory for collecting information about an associated user's video viewing preferences;
a controller coupled to the memory, wherein the controller processes the information in a predetermined manner to select a start-up channel; and
a display coupled to the processor for displaying video content corresponding to the selected start-up channel.

17. The electronic equipment of claim 16, wherein the electronic equipment is a mobile telephone.

18. The electronic equipment of claim 16, wherein the display includes a one or more alternative channels in a text format.

19. A program stored on a machine usable medium selecting a start-up channel with an electronic equipment that receives video data from a time-sliced data stream having video data corresponding to each of a plurality of channels, the program comprising executable logic to: collect information about an associated user's video viewing preferences; process the information in a predetermined manner; determine a start-up channel based upon the collected information; receive video data corresponding to the start-up channel; and drive a display in accordance with the video data corresponding to the start-up channel

20. The program according to claim 19 further comprising logic to drive a display to display one or more alternative channels on the display.

21. The program according to claim 19, wherein the logic to collect information monitors user behavior and/or viewing preferences to determine the start-up channel.

22. The program according to claim 19, wherein the logic to determine the start-up channel utilizes more than one of the associated user's video viewing preferences.
